(19) United States
(12) Patent Application Publication
(10) Pub. No.: US 2026/0073285 A1
(43) Pub. Date: Mar. 12, 2026

(54) TREATING LOSSY DATA TO OPTIMIZE PERFORMANCE OF A MACHINE LEARNING CLASSIFIER

(71) Applicant: Dell Products L.P., Round Rock, TX (US)

(72) Inventors: Rômulo Teixeira de Abreu Pinho, Niterói (BR); Vinicius Michel Gottin, Rio de Janeiro (BR); Paulo de Figueiredo Pires, Niterói (BR); Alex Laier Bordignon, Niterói (BR); João Victor Daher Daibes, Niterói (BR); Franklin Jordan Ventura Quico, Niterói (BR)

(21) Appl. No.: 18/883,622

(22) Filed: Sep. 12, 2024

(51) Int. Cl. G06N 20/00

(52) U.S. Cl. CPC G06N 20/00

(57) ABSTRACT

Techniques for enabling an ML classifier, which is trained on non-lossy data, to operate on lossy data without a reduction in performance are disclosed. Lossy data is received. A data enhancer is accessed. The data enhancer operates in conjunction with an ML classifier tasked with solving an end-task. The data enhancer treats the lossy data in a manner that prevents use of the lossy data by the ML classifier from introducing a bias into a classification operation performed by the ML classifier. In response to accessing treated lossy data from the data enhancer, the ML classifier performs the classification operation using the treated lossy data.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to techniques for addressing bandwidth limitations in a network edge environment. More particularly, at least some embodiments relate to systems, hardware, software, computer-readable media, and methods for addressing network edge bandwidth limitations with lossy data compression and data reconstruction.

### BACKGROUND

In the field of artificial intelligence, it is common for classification models based on Machine Learning (ML) techniques to be trained and evaluated using uncompressed, non-lossy data. This is relevant because the accuracy and error of these models largely depend on the quality of the original data. However, in real-world applications, the data processed by these models have often been compressed and decompressed beforehand, resulting in a loss of quality (i.e. lossy data). This data degradation can significantly reduce the efficiency of the models and can negatively impact their accuracy.

Typically, it is desirable for ML-based classification models to maintain accuracy above a specific threshold. This criteria sets a limit for compression algorithms, thereby determining an acceptable maximum level of compression and, consequently, a maximum permitted loss of quality.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example computing architecture for mitigating the introduction of a bias that lossy data might have on an ML classifier.

FIG. 2 illustrates a process flow for mitigating bias.

FIG. 3 illustrates a process for training a data enhancer to mitigate bias.

FIGS. 4, 5, 6, 7, and 8 provide various experimental data demonstrating improved performance of the data enhancer and classifier combination.

FIG. 9 illustrates a flowchart of an example method for mitigating bias.

FIG. 10 illustrates a flowchart for training the data enhancer.

FIG. 11 illustrates an example computer system that can be configured to perform any of the disclosed operations.

### DETAILED DESCRIPTION

Some techniques exist to enhance the reconstruction quality of lossy compressed data, and these techniques aim to reduce bandwidth costs and save sensor battery life. With these traditional techniques, sensors can transmit the same number of bits while improving the data quality at the receiving end. However, the traditional techniques aimed only at restoring the quality of the original sample as much as possible. Namely, these traditional techniques did not consider scenarios where the end-task is solved by a classification model. Thus, these old techniques do not include functionality to treat certain characteristics that are specific to classifier models.

The disclosed embodiments, on the other hand, are directed to the configuration of a so-called “data enhancer” whose objective is to structure lossy data in a manner so as to optimize and potentially maximize the performance of a subsequent ML classifier. Thus, instead of providing an optimizer that attempts to recreate an original set of data after any number of transformations and other operations have been performed on that original set of data, the disclosed embodiments receive transformed data and then restructure and optimize the transformed data so that it ends up having a state that is better suited for processing by a classifier. In other words, the embodiments eliminate, or at least reduce, the impact that lossy data might have on an ML classifier by structuring the lossy data in a manner so that the ML classifier operates the same regardless of whether it is classifying non-lossy data or lossy data. It has been observed that this methodological adjustment results in higher performance in the execution of the end-task (i.e. the classifier).

The disclosed embodiments bring about numerous benefits, advantages, and practical applications to how lossy data is processed. One significant benefit is that the described classifier can be treated as a black-box in that no retraining of the classifier is required when it is used in the disclosed architecture.

As another benefit, the disclosed embodiments address scenarios where an ML classification model receives inputs through a communication channel with inherent bandwidth limitations. These scenarios are increasingly common as ML based classification models are typically implemented in the cloud, while the input data comes from edge nodes in the network. This configuration means that various types of edge data, such as images, time series, and videos are often transferred to the cloud via a communication channel that may not always have the necessary resources to transfer the data without prior processing. To meet this challenge, it is common to apply lossy compression algorithms to the data at the edge nodes, thus significantly reducing the amount of network resources required to transfer the data to the cloud. However, lossy compression can degrade the original quality of the data, introducing distortion.

One noteworthy aspect to consider is that cloud-based ML classification models are generally trained and evaluated using uncompressed, non-lossy data. This discrepancy between the training data (uncompressed) and the operational data (compressed) can lead to a decrease in the accuracy of the model. Introducing compressed data into the model, which has not been designed or optimized to handle such changes, poses the risk of significantly reducing its performance.

Thus, one significant challenge in the technical field is compressing the data at the edge nodes as much as possible while minimizing the impact on the accuracy of the classification model. The disclosed embodiments advantageously address this challenge by proposing a Neural Network Data Enhancer (DE) that aims to improve the decompressed data in the cloud before it enters the classification model. This approach not only aims to mitigate the negative effect on accuracy by introducing distorted data into the classifier but also operates without requiring labeled data, which is a common scenario in deployment and production environments.

The disclosed embodiments are thus beneficially directed to a methodology for enhancing compressed (and decompressed) data handling for edge-to-cloud ML environments. This methodology balances achieving higher compression at the edge and minimizing the loss of quality in the compressed data while ensuring classification accuracy in the cloud. Beneficially, the disclosed principles enable a number of advantages. One advantage involves the selection of the right or best level (or at least a selected level) of lossy data compression at the edge to satisfy ML application requirements in the cloud (e.g., to achieve a threshold success level with respect to its classification operations). Another advantage involves leveraging a pre-trained, black-box classifier as an ML application, without the need to collect labelled data for the selection of compression. Yet another advantage involves optimizing a data enhancing mechanism oriented to ML end-tasks, as opposed to simply decompressing the data to match the original data quality. Accordingly, these and numerous other benefits will now be discussed in more detail throughout the remaining portions of this disclosure.

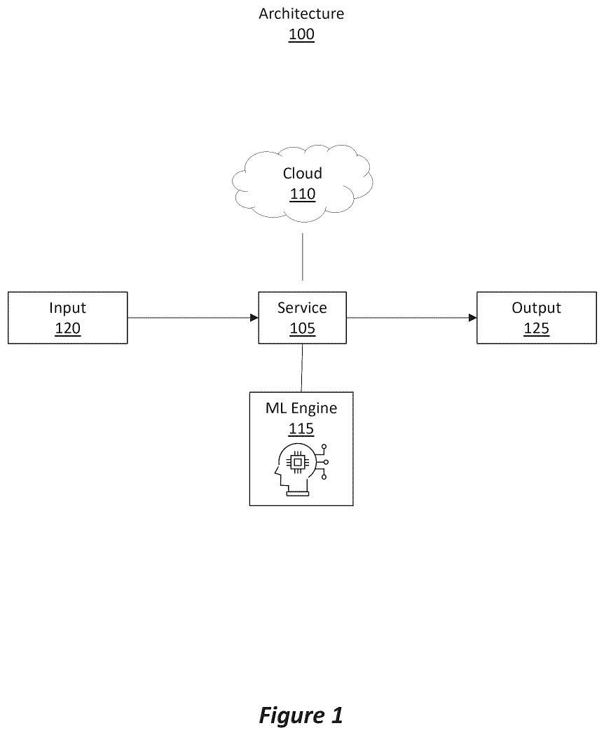

Attention will now be directed to FIG. 1, which illustrates an example architecture 100 in which the disclosed principles may be employed. Architecture 100 shows a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a local service operating on a local device. In some implementations, service 105 is a cloud service operating in a cloud 110 environment. In some implementations, service 105 is a hybrid service that includes a cloud component operating in the cloud and a local component operating on a local device. These two components can communicate with one another.

Service 105 generally represents the “data enhancer” component mentioned earlier. In particular, service 105 receives input 120. This input 120 may be the lossy data mentioned previously, and the input 120 can be received from any number of edge devices. The input 120 may have been subjected to a compression and decompression operation.

Service 105 is tasked with structuring the input 120 in a manner so it can be optimally worked on by a subsequent classifier. Thus, service 105 operates on the input 120 to produce the output 125, which, as mentioned above, has been structured so it can be operated on in a manner that allows the classifier to operate the same regardless of whether it is operating on raw, non-lossy data or on lossy data.

In particular, service 105 is tasked with addressing the challenge of working with compressed data, especially in situations where insufficient network resources limit data transmission from edge nodes to the cloud. Service 105 can be implemented as an additional process in the cloud 110. As mentioned above, service 105 can also be named a “Neural Network Data Enhancer (DE).” Service 105 is applied to data before that data is processed by the classification model. This process aims to improve the usability of the compressed and decompressed data with respect to the classifier.

The proposed methodology for constructing the data enhancer (i.e. service 105) is oriented to the performance of the black-box classifier that solves an end-task. In this context, the data enhancer is built to accommodate the relevant characteristics for the correct solution of the end-task. The proposed methodology does not require access to the classifier model's internal parameters or to data labels.

Experimentally, it has been demonstrated that the proposed methodology is highly effective. The disclosed principles have achieved a higher compression rate compared to conventional compression and decompression methods while still meeting the ML classifier's application requirements. Additionally, the disclosed methodology has been applied in a scenario where a classification model trained with uncompressed data processes compressed and decompressed data. The results show that, with the disclosed approach, the classification model's accuracy significantly improves compared to the traditional approaches mentioned earlier. These findings have been validated experimentally and are illustrated graphically in subsequent Figures.

It is also worth mentioning that this methodology can be useful in various common scenarios, such as applications where the model runs in the cloud and a bandwidth limitation is to be circumvented. This methodology can also be used in cases where there is limited availability of computational power at the emitting end (e.g., in the edge) in order to modify traditional compression pipelines, making them asymmetric and having lower distortions.

Service 105 thus improves the performance of a classification application that, though being trained with a raw dataset, is fed with data distorted by a lossy compression (and decompression) method. Such situations often arise in Edge-to-Cloud AI/ML deployments where data collected at the edge is not sent in raw format for classification in the cloud due to bandwidth limitations.

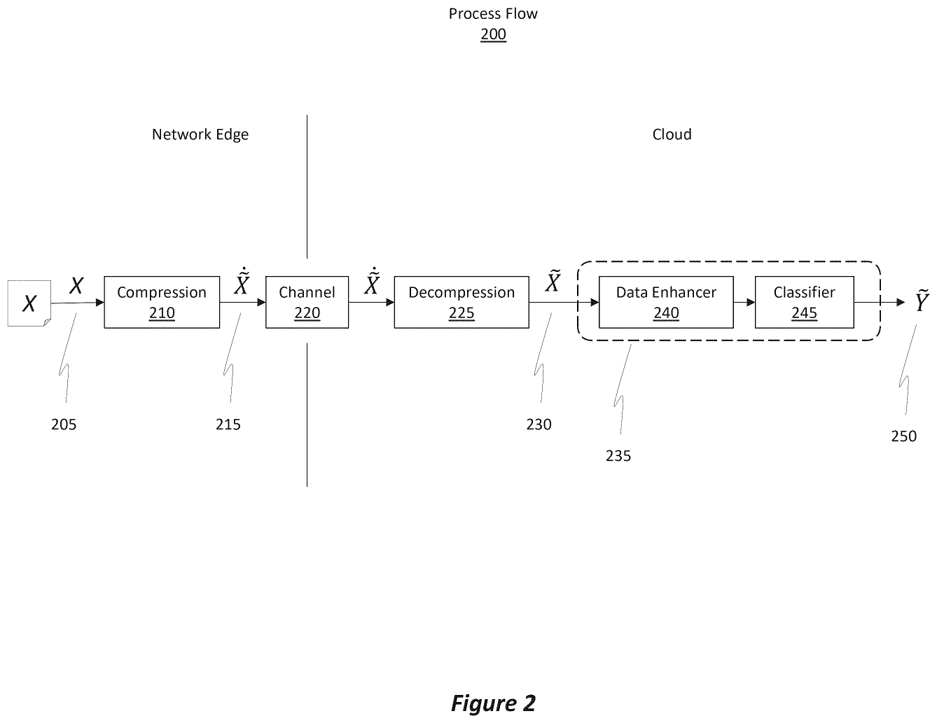

In some scenarios, the embodiments assume the existence of an already trained classification model and a dataset compatible with the model that solves the end-task of interest. In addition, the embodiments can assume the existence of limitations in a communication channel bandwidth (or, equivalently, in the capacity of a storage medium) that composes the classification pipeline such that lossy compression techniques are applied. FIG. 2 provides additional details.

FIG. 2 shows a process flow 200 that illustrates the organization of the disclosed classification pipeline. A data sample X 205, which is to be classified, is collected (e.g., at the edge) and compressed with a lossy compression algorithm, as shown by compression 210. Compression 210 generates a compressed version of the data \tilde{\dot{X}} 215. The compressed samples are sent through a limited bandwidth channel 220 to the cloud for classification.

Upon arrival in the cloud, the compressed samples are decompressed with a compatible decompressor, as shown by decompression 225, to generate reconstituted samples (i.e. distorted data \tilde{X} 230). Due to the lossy compression, the decompressed samples present distortions in relation to the original data X 205. Such distortions can be magnified when, for example, there are computational limitations in the sending entity or when the compression algorithm is not sufficiently adjusted to the transmitted data. As a result, the classification model (e.g., classifier 245) may be severely affected, potentially yielding a large proportion of incorrect label assignments \tilde{Y} 250.

In this context, the disclosed embodiments insert, into the pipeline of process flow 200, a data enhancer 240 in the cloud. The data enhancer 240 is representative of service 105 of FIG. 1. In some scenarios, service 105 includes a combination of both the data enhancer 240 and the classifier 245, as shown by the combination 235. In other scenarios, service 105 includes only the data enhancer 240 (which can be a plugin component), and the classifier 245 is a distinct entity relative to the service 105.

Data enhancer 240 is oriented to minimize the error of the end-task classifier 245. That is, data enhancer 240 is structured to treat the distorted data \tilde{X} 230 before submitting that data as input to the classifier 245, where the treatment is designed to enable the classifier 245 to operate without bias when fed lossy data.

Whether at the time of inference or at the time of training, the disclosed methodology eliminates the need for access to labels of the samples, which are usually unavailable after the end-task classifier model (i.e. classifier 245) is deployed. Furthermore, the data enhancer 240 does not require access to the classifier 245's internal parameters for training or operation, so the end-task classifier 245 can beneficially be treated as a black-box element.

It should be noted that one aim is not necessarily to improve the original performance of the classifier by enhancing the data; rather, it is the intention to preserve the classifier's performance observed on raw data in situations where a lossy compression algorithm distorts the data. Thus, in some scenarios, one objective is to prevent, or at least mitigate, the compression from introducing bias into the classification process.

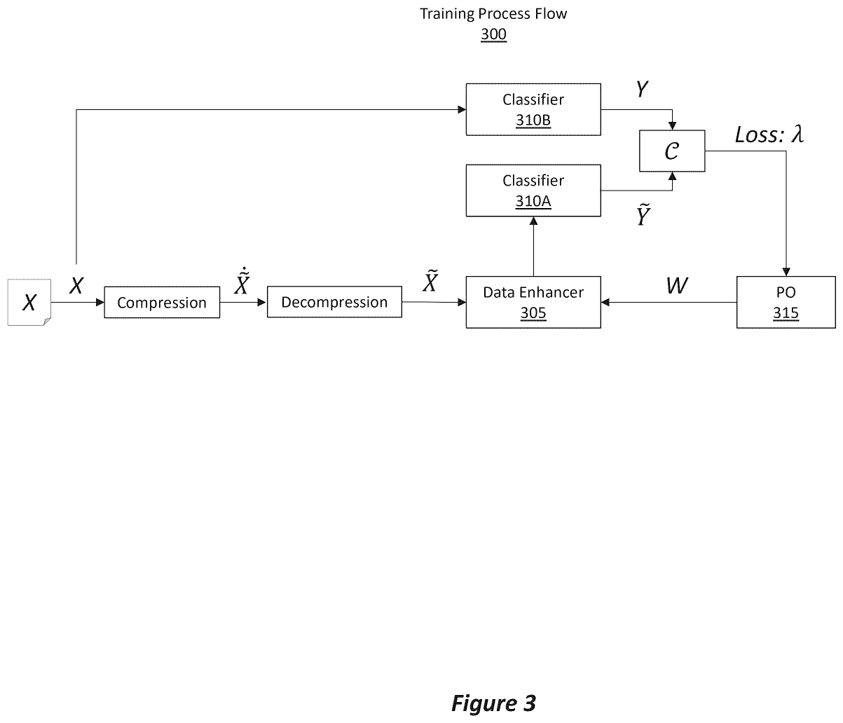

FIG. 3 shows a training process flow 300 for the data enhancer 240 of FIG. 2 and the service 105 of FIG. 1. In training process flow 300, a set of data {X} is subjected to a lossy compression technique (thus forming the set {\tilde{\dot{X}}}) at the edge in order to obtain a set of distorted individuals {\tilde{X}} that will compose the input for the data enhancer 305, which is representative of the data enhancers mentioned thus far. In turn, the data enhancer 305 transforms each distorted individual \tilde{X} into an element with the same dimensions of X, to be evaluated by the classifiers 310A and 310B, which are illustrated in FIG. 3 as separate components but which can be the same component used at different instants of time. In some cases, different instances of the same classifier can be used simultaneously or at different times. In other cases, the same classifier is used at different times.

Data enhancer 305 is trained based on an optimization algorithm driven by a loss function. As mentioned before, one goal of the optimization process (e.g., as shown by parameter optimization (PO) 315) is to obtain the set of parameters W of the data enhancer 305, such that when the classifier 310A is fed with the output of data enhancer 305, the classifier 310A yields performance that is compatible with that observed for the original sample X when fed to classifier 310B. Thus, the delta difference between the output of classifier 310A, which is fed input from data enhancer 305 that has been optimized, is desirable to be as small as possible relative to the output of classifier 310B, which is fed the original input.

The optimization of the parameters for the data enhancer 305 is based on comparing the expected output Y for the classifier 310B when fed with a raw individual X with the output \tilde{Y} of classifier 310A when fed with the distorted individual \tilde{X}. Note that by “output,” it is meant the class probabilities assigned by the classifier 310A/B. A comparison function (e.g., shown by [symbol] ) (e.g., cross entropy) that is adequate to the encoding of the classifier 310A/B output is expected as input of the loss function. Finally, [symbol] is applied to Y and \tilde{Y} to get the λ loss.

It should also be noted that the training process probes the classifier twice. First, the output label, Y, is obtained for the original data individual X. Then, the data is compressed, decompressed, passed through the data enhancer 305 and fed to the classifier 310A to produce label \tilde{Y}. Nonetheless, only the parameters W of the data enhancer 305 are updated in the optimization process. The parameters of the classifier 310A/B remain frozen or unmodified, despite the data enhancer 305 and the classifier 310A/B (potentially) forming a single architecture for the enhancement.

In some scenarios, a single architecture comprising the combination of the data enhancer and the classifier is an advantage. Namely, it is expected that the data enhancer will learn data representations that make the classifier behave as close as possible to when it is fed with the original data. A consequence, the architecture can remain agnostic about the output of the data enhancer. In some scenarios, the data enhancer will act like an advanced feature extractor that transforms its input data, \tilde{X}, into something that makes the classifier behave as though it were operating on the original data. The transformed data may or may not be similar to the original sample X, but it remains irrelevant for the overall process. The transformations performed by the data enhancer 305 may include any type of transformation, including, but not limited to, any type of up-scaling, down-scaling, smoothing, aggregation, generalization, normalization, discretization, constructive transformations, destructive transformation, aesthetic transformations, structural transformations, data mapping, reformatting, attribute construction, data manipulation, and so on.

As mentioned above, traditional approaches aim to reconstruct an intermediary representation that is as similar as possible to X before feeding it to the classifier. As shown herein, the disclosed data enhancer performs a different operation and tends to perform better.

Next, empirical results will be presented in order to support the above assertions. To this end, the disclosed pipeline is implemented, and an end-task classification problem is chosen, where the task is desired to identify hand-drawn digits in the MNIST (modified national institute of standards and technology) dataset and ten kinds of hand-drawn Japanese Hiragana characters from the Kuzushiji-MNIST dataset (X).

A classifier model (Cl) based on a multi-layer perceptron (MLP) architecture is created and, to perform the data compression, a data compressor based on the discrete cosine transform (Comp/Decomp) is used. For the comparison function ( [symbol] ), cross-entropy was chosen.

To run the experiments, the datasets X were divided into training and test sets with a training: test ratio of 6:1. A validation set was also taken from the training set with 10% of its individuals to be used during training.

For the classifier, an MLP architecture with three layers (with, respectively, 784, 350 and 10 neurons) was adopted. For the data enhancer, an MLP architecture with three layers with, respectively, 784, 350 and 784 neurons was chosen.

In all cases, 7 training epochs proved enough, with batches of 256 individuals, using the Adam algorithm with a learning rate of 0.001 and [symbol] norm weight decay of 10⁻⁵. One data enhancer was trained for each compression ratio (CR) parameter of Comp, where the lower the CR value, the greater the level of lossiness (and the distortions) of the decompressed image.

For comparison, the test also trained an auto-encoder (AE) neural network for each evaluated CR. The AE, with the same topology as the data enhancer (DE), was aimed at reconstructing the decompressed (distorted) samples to make them as similar as possible to the original ones before feeding them to the classifier.

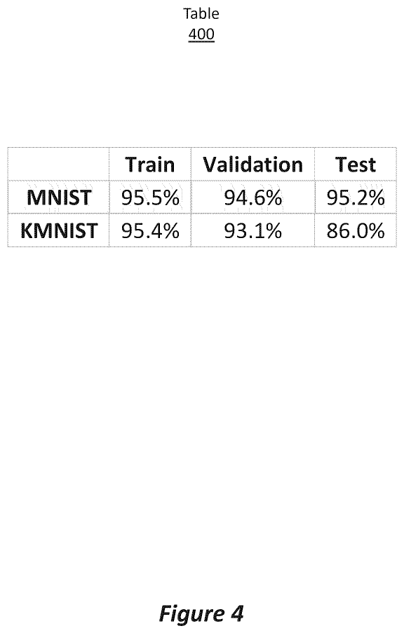

In FIG. 4, table 400 organizes the accuracies obtained by the model trained with each dataset. Both cases present high training accuracy without significant variation against validation accuracies, which indicates that the classifiers did not overfit.

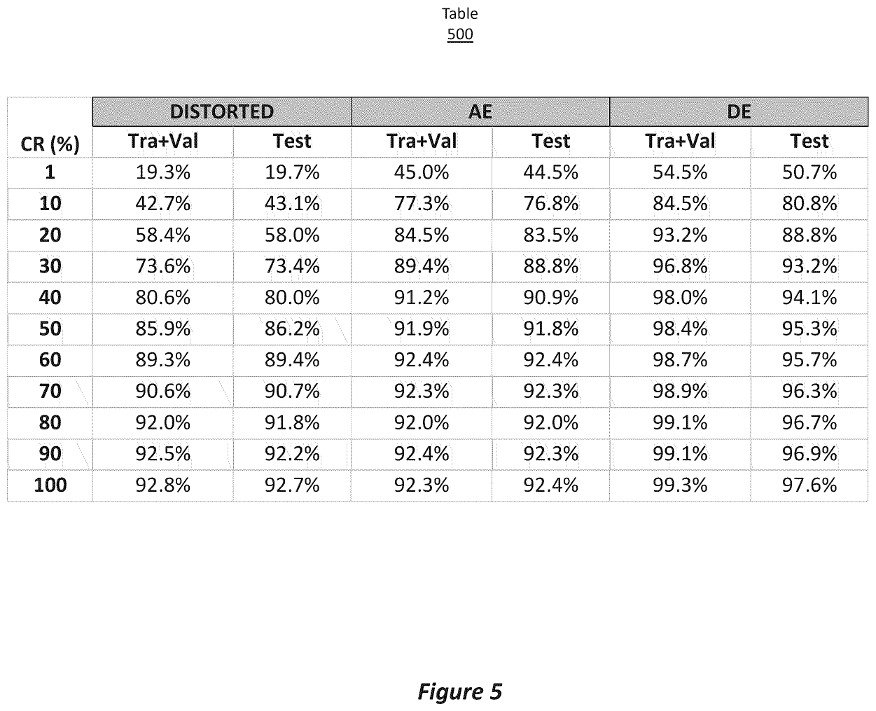

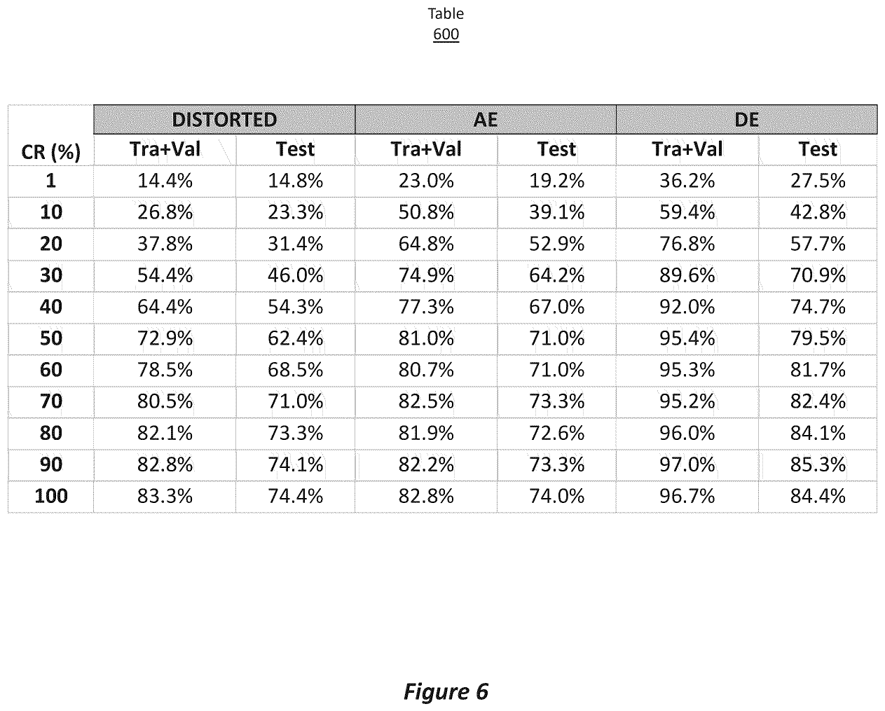

Table 500 in FIG. 5 and table 600 of FIG. 6 refer to the described classifiers which were trained and tested, respectively, with individuals from the MNIST and KMNIST datasets. The column DISTORTED shows the accuracy of the classifier when it was fed with data compressed (and decompressed) by a Discrete Cosine Transform (DCT) compressor, with several compression ratios (CR). The column AE shows the accuracy of the classifier when the auto-encoder model (AE) was applied to the decompressed data to remove the distortions introduced in the lossy compression-decompression process. Finally, the column DE shows the accuracy of the classifier when the method described herein was used to restore the data.

Recall, the lower the CR, the greater the distortions caused to each analyzed individual. Therefore, it is expected that the classifiers will reach higher accuracies for high CR values. One objective is to increase the accuracy of the classifiers by applying some data restoring mechanism after decompression and before feeding the data to the classifier.

One can observe from the tables that, in both datasets, the pipeline with AE was indeed able to improve the accuracy of the classification compared to the one that directly classifies distorted individuals. However, the proposed DE improved over the AE by 6% on average on the MNIST dataset and by 15% on the KMNIST dataset. Furthermore, one can observe that, while the AE reaches a plateau that roughly matches the accuracy obtained with the distorted data, the use of the DE improves such accuracy even more.

The additional improvements observed with the DE happen because it is eventually able to transform the data into a representation that facilitates the job of the classifier. Namely, while the AE aims to restore the data to its original form, the DE acts like a feature extractor that is optimized to obtain from the distorted data the most relevant pieces of information for the classifier to correctly assign labels.

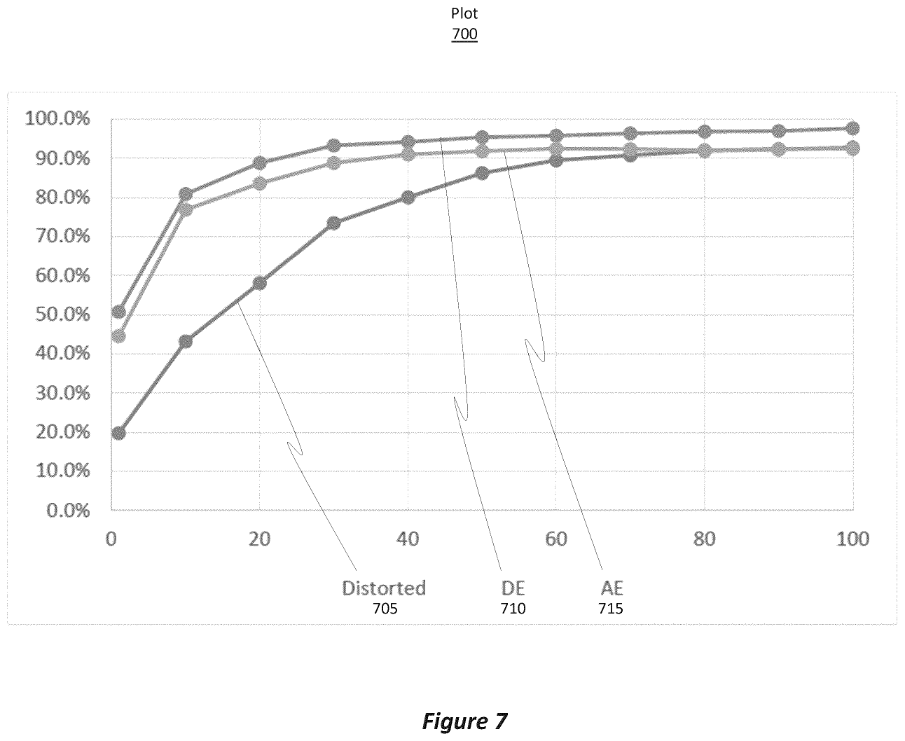

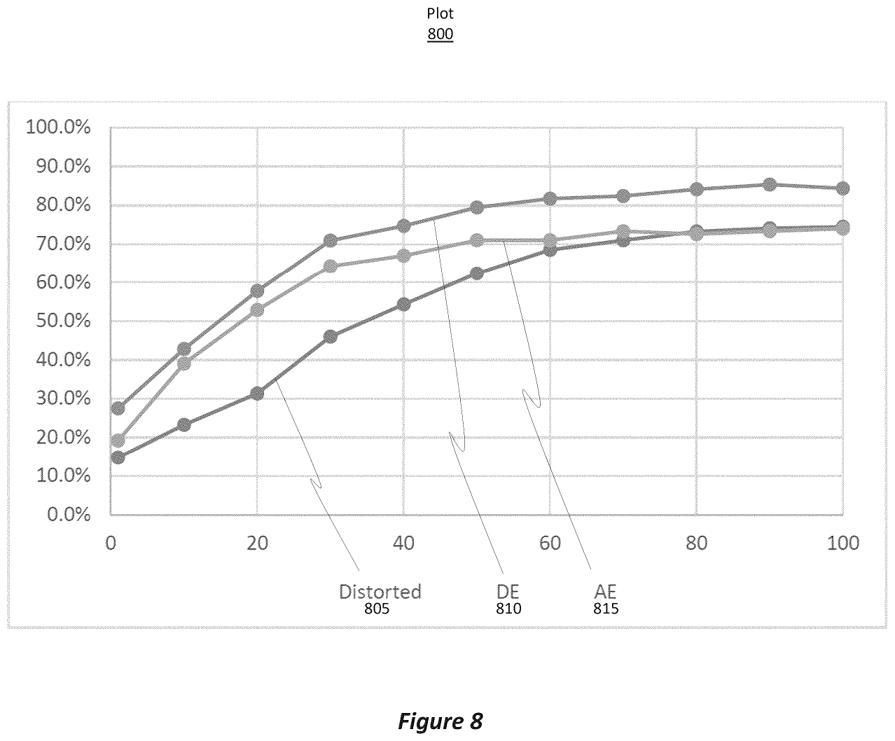

FIG. 7 shows a plot 700 corresponding to table 500 of FIG. 5. Plot 700 includes plotted data for the distorted 705 data, the DE 710, and the AE 715, as described above. Similarly, FIG. 8 shows a plot 800 corresponding to table 600 of FIG. 6. Plot 800 includes plotted data for the distorted 805 data, the DE 810, and the AE 815.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

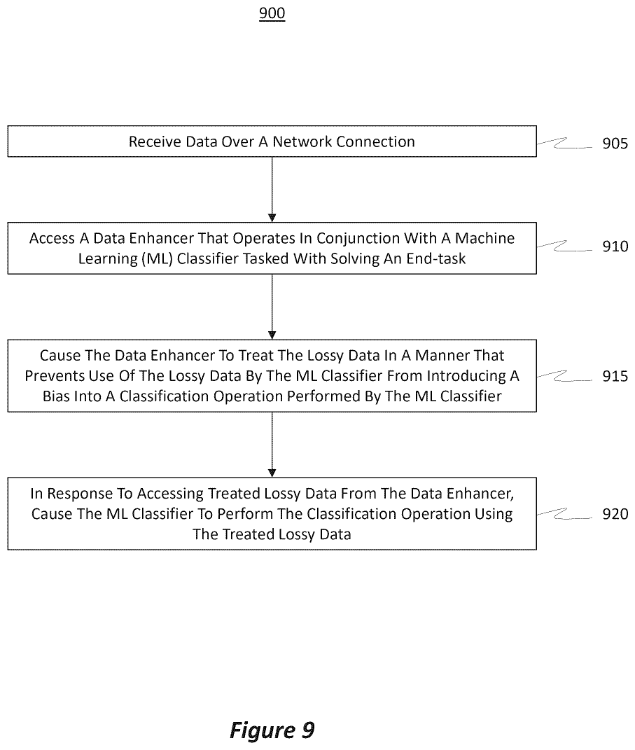

Attention will now be directed to FIG. 9, which illustrates a flowchart of an example method 900 for treating lossy data in a manner so that it does not introduce bias into a classification operation performed by an ML classifier that has been trained on only non-lossy data. Method 900 can be implemented within architecture 100 of FIG. 1; furthermore, method 900 can be implemented by service 105 (or any of the data enhancers mentioned herein).

Method 900 includes an act (act 905) of receiving data over a network connection. The data is lossy data in that the lossy data includes one or more distortions as compared to an original version of the data. For instance, the distorted data \tilde{X} 230 of FIG. 2 is representative of this lossy data. In some implementations, after receiving the data over the network connection, the data is decompressed.

In some scenarios, the lossy data is received from an edge network device. In some scenarios, the lossy data was previously subjected to a data compression operation and a data decompression operation. Optionally, the network connection can be a limited bandwidth network channel. As a result, the lossy data can be received over the limited bandwidth network channel.

Act 910 includes accessing a data enhancer, such as the data enhancer 240 of FIG. 2. The data enhancer operates in conjunction with a machine learning (ML) classifier (e.g., classifier 245 of FIG. 2) tasked with solving an end-task. In some implementations, a single architecture includes a combination of the data enhancer and the ML classifier.

In some scenarios, the ML classifier is pre-trained to solve end-tasks. This pre-training is based on raw, non-lossy data. Also, parameters of the ML classifier are caused to remain unchanged during at least some time periods while the data enhancer is operating with the classifier. The data enhancer is trained to minimize an error of the ML classifier by treating the lossy data prior to the lossy data being submitted to the ML classifier. In some scenarios, pre-training of the ML classifier is performed without use of any lossy data. Optionally, the data enhancer can refrain from accessing the parameters of the ML classifier for at least some period of time. For instance, the period of time may be a time period in between when the ML classifier is subjected to an external update. Thus, the ML classifier's parameters remain unchanged in-between updates, and the data enhancer does not access those parameters. In some scenarios, the period of time between ML classifier updates can be extensive, such as weeks, months, or even years.

Act 915 includes causing the data enhancer to treat the lossy data. This treatment is performed in a manner that prevents use of the lossy data by the ML classifier from introducing a bias into a classification operation performed by the ML classifier.

In response to accessing treated lossy data from the data enhancer, act 920 includes causing the ML classifier to perform the classification operation using the treated lossy data. Thus, the end-task can be solved.

In some implementations, method 900 can further include an act of modifying a level of lossy data compression at an edge device, which provided the data, to satisfy a criteria of the ML classifier. For instance, if the ML classifier is not able to adequately classify the output from the data enhancer (e.g., achieve a threshold level of classification success), then the data compression may need to be modified to have less compression so that fewer distortions are introduced into the data. By modifying the compression level, higher quality data can be processed by the data enhancer.

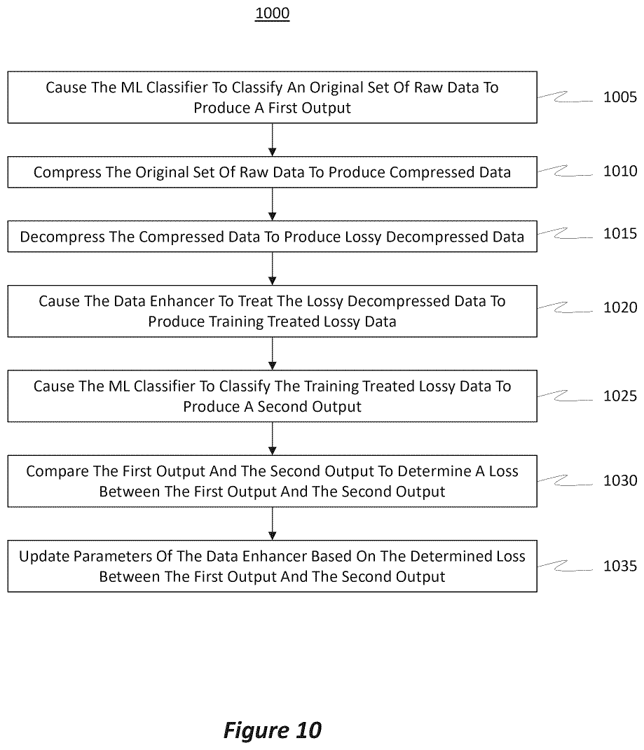

FIG. 10 shows an example process 1000 of pre-training the ML classifier, or rather, of training the data enhancer. Process 1000 corresponds to the operations illustrated in FIG. 3 and includes an act (act 1005) of causing the ML classifier to classify an original set of raw data to produce a first output.

Act 1010 includes compressing the original set of raw data to produce compressed data. Act 1015 includes decompressing the compressed data to produce lossy decompressed data. Act 1020 includes causing the data enhancer to treat the lossy decompressed data to produce training treated lossy data.

Act 1025 includes causing the ML classifier to classify the training treated lossy data to produce a second output. Act 1030 includes comparing the first output and the second output to determine a loss between the first output and the second output. Finally, act 1035 includes updating parameters of the data enhancer based on the determined loss between the first output and the second output. Those parameters are updated in an attempt to reduce the loss or delta between the two outputs.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

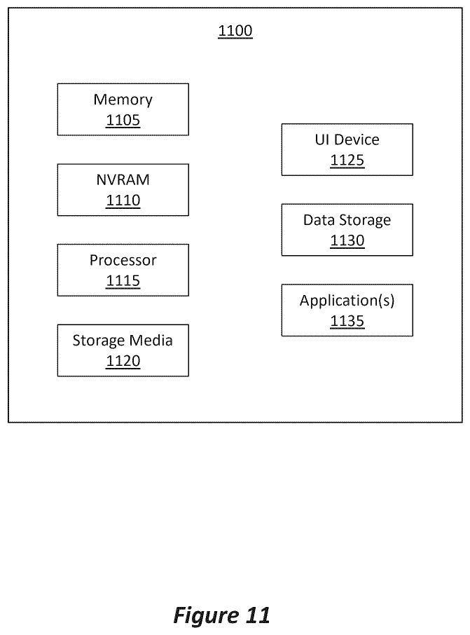

With reference briefly now to FIG. 11, any one or more of the entities disclosed, or implied, by the Figures and/or elsewhere herein, may take the form of, or include, or be implemented on, or hosted by, a physical computing device, one example of which is denoted at 1100. Also, where any of the aforementioned elements comprise or consist of a virtual machine (VM), that VM may constitute a virtualization of any combination of the physical components disclosed in FIG. 11.

In the example of FIG. 11, the physical computing device 1100 includes a memory 1105 which may include one, some, or all, of random access memory (RAM), non-volatile memory (NVM) 1110 such as NVRAM for example, read-only memory (ROM), and persistent memory, one or more hardware processors 1115, non-transitory storage media 1120, UI device 1125, and data storage 1130. One or more of the memory 1105 of the physical computing device 1100 may take the form of solid-state device (SSD) storage. Also, one or more applications 1135 may be provided that comprise instructions executable by one or more hardware processors 1115 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 1100 may also be representative of an edge system, a cloud-based system, a datacenter or portion thereof, or other system or entity.

The disclosed embodiments can be implemented in numerous different ways, as described in the various different clauses recited below.

Clause 1. A method comprising: receiving data over a network connection, wherein the data is lossy data, and wherein the lossy data includes one or more distortions as compared to an original version of the data; accessing a data enhancer that operates in conjunction with a machine learning (ML) classifier tasked with solving an end-task, wherein: the ML classifier is pre-trained to solve end-tasks, said pre-training being based on raw, non-lossy data, parameters of the ML classifier are caused to remain unchanged for at least a determined period of time, and the data enhancer is trained to minimize an error of the ML classifier by treating the lossy data prior to the lossy data being submitted to the ML classifier; causing the data enhancer to treat the lossy data in a manner that prevents use of the lossy data by the ML classifier from introducing a bias into a classification operation performed by the ML classifier; and in response to accessing treated lossy data from the data enhancer, causing the ML classifier to perform the classification operation using the treated lossy data.

Clause 2. The method of any preceding clause, wherein the lossy data is received from an edge network device.

Clause 3. The method of any preceding clause, wherein the lossy data was previously subjected to a data compression operation and a data decompression operation.

Clause 4. The method of any preceding clause, wherein said network connection is a limited bandwidth network channel such that the lossy data is received over the limited bandwidth network channel.

Clause 5. The method of any preceding clause, wherein the method further includes modifying a level of lossy data compression at an edge device, which provided the data, to satisfy a criteria of the ML classifier.

Clause 6. The method of any preceding clause, wherein said pre-training of the ML classifier is performed without use of any lossy data.

Clause 7. The method of any preceding clause, wherein training said data enhancer includes: causing the ML classifier to classify an original set of raw data to produce a first output; compressing the original set of raw data to produce compressed data; decompressing the compressed data to produce lossy decompressed data; causing the data enhancer to treat the lossy decompressed data to produce training treated lossy data; causing the ML classifier to classify the training treated lossy data to produce a second output; comparing the first output and the second output to determine a loss between the first output and the second output; updating parameters of the data enhancer based on the determined loss between the first output and the second output.

Clause 8. The method of any preceding clause, wherein, after receiving the data over the network connection, the data is decompressed.

Clause 9. The method of any preceding clause, wherein a single architecture includes a combination of the data enhancer and the ML classifier.

Clause 10. The method of any preceding clause, wherein the data enhancer refrains from accessing the parameters of the ML classifier.

Clause 11. A non-transitory storage medium having stored therein instructions that are executable by one or more hardware processors to cause the one or more hardware processors to: receive data over a network connection, wherein the data is lossy data, and wherein the lossy data includes one or more distortions as compared to an original version of the data; access a data enhancer that operates in conjunction with a machine learning (ML) classifier tasked with solving an end-task, wherein: the ML classifier is pre-trained to solve end-tasks, said pre-training being based on raw, non-lossy data, parameters of the ML classifier are caused to remain unchanged for at least a determined period of time, and the data enhancer is trained to minimize an error of the ML classifier by treating the lossy data prior to the lossy data being submitted to the ML classifier; cause the data enhancer to treat the lossy data in a manner that prevents use of the lossy data by the ML classifier from introducing a bias into a classification operation performed by the ML classifier; and in response to accessing treated lossy data from the data enhancer, cause the ML classifier to perform the classification operation using the treated lossy data.

Clause 12. The non-transitory storage medium of any preceding clause, wherein the data enhancer refrains from accessing the parameters of the ML classifier.

Clause 13. The non-transitory storage medium of any preceding clause, wherein the lossy data is received from an edge network device, and wherein the lossy data was previously subjected to a data compression operation and a data decompression operation.

Clause 14. The non-transitory storage medium of any preceding clause, wherein said network connection is a limited bandwidth network channel such that the lossy data is received over the limited bandwidth network channel.

Clause 15. The non-transitory storage medium of any preceding clause, wherein said pre-training of the ML classifier includes: causing the ML classifier to classify an original set of raw data to produce a first output; compressing the original set of raw data to produce compressed data; decompressing the compressed data to produce lossy decompressed data; causing the data enhancer to treat the lossy decompressed data to produce training treated lossy data; causing the ML classifier to classify the training treated lossy data to produce a second output; comparing the first output and the second output to determine a loss between the first output and the second output; updating parameters of the data enhancer based on the determined loss between the first output and the second output.

Clause 16. A computer system comprising: one or more processors; and one or more hardware storage devices that store instructions that are executable by the one or more processors to cause the computer system to: receive data over a network connection, wherein the data is lossy data, and wherein the lossy data includes one or more distortions as compared to an original version of the data; access a data enhancer that operates in conjunction with a machine learning (ML) classifier tasked with solving an end-task, wherein: the ML classifier is pre-trained to solve end-tasks, said pre-training being based on raw, non-lossy data, parameters of the ML classifier are caused to remain unchanged for at least a determined period of time, and the data enhancer is trained to minimize an error of the ML classifier by treating the lossy data prior to the lossy data being submitted to the ML classifier; cause the data enhancer to treat the lossy data in a manner that prevents use of the lossy data by the ML classifier from introducing a bias into a classification operation performed by the ML classifier; and in response to accessing treated lossy data from the data enhancer, cause the ML classifier to perform the classification operation using the treated lossy data.

Clause 17. The computer system of any preceding clause, wherein the data enhancer refrains from accessing the parameters of the ML classifier.

Clause 18. The computer system of any preceding clause, wherein the lossy data is received from an edge network device, and wherein the lossy data was previously subjected to a data compression operation and a data decompression operation.

Clause 19. The computer system of any preceding clause, wherein said network connection is a limited bandwidth network channel such that the lossy data is received over the limited bandwidth network channel.

Clause 20. The computer system of any preceding clause, wherein said pre-training of the ML classifier includes: causing the ML classifier to classify an original set of raw data to produce a first output; compressing the original set of raw data to produce compressed data; decompressing the compressed data to produce lossy decompressed data; causing the data enhancer to treat the lossy decompressed data to produce training treated lossy data; causing the ML classifier to classify the training treated lossy data to produce a second output; comparing the first output and the second output to determine a loss between the first output and the second output; updating parameters of the data enhancer based on the determined loss between the first output and the second output.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
receiving data over a network connection, wherein the data is lossy data, and wherein the lossy data includes one or more distortions as compared to an original version of the data;
accessing a data enhancer that operates in conjunction with a machine learning (ML) classifier tasked with solving an end-task, wherein:
the ML classifier is pre-trained to solve end-tasks, said pre-training being based on non-lossy data,
parameters of the ML classifier are caused to remain unchanged for at least a determined period of time, and
the data enhancer is trained to minimize an error of the ML classifier by treating the lossy data prior to the lossy data being submitted to the ML classifier;
causing the data enhancer to treat the lossy data in a manner that prevents use of the lossy data by the ML classifier from introducing a bias into a classification operation performed by the ML classifier; and
in response to accessing treated lossy data from the data enhancer, causing the ML classifier to perform the classification operation using the treated lossy data.

2. The method of claim 1, wherein the lossy data is received from an edge network device.

3. The method of claim 1, wherein the lossy data was previously subjected to a data compression operation and a data decompression operation.

4. The method of claim 1, wherein said network connection is a limited bandwidth network channel such that the lossy data is received over the limited bandwidth network channel.

5. The method of claim 1, wherein the method further includes modifying a level of lossy data compression at an edge device, which provided the data, to satisfy a criteria of the ML classifier.

6. The method of claim 1, wherein said pre-training of the ML classifier is performed without use of any lossy data.

7. The method of claim 1, wherein training said data enhancer includes:
causing the ML classifier to classify an original set of raw data to produce a first output;
compressing the original set of raw data to produce compressed data;
decompressing the compressed data to produce lossy decompressed data;
causing the data enhancer to treat the lossy decompressed data to produce training treated lossy data;
causing the ML classifier to classify the training treated lossy data to produce a second output;
comparing the first output and the second output to determine a loss between the first output and the second output;
updating parameters of the data enhancer based on the determined loss between the first output and the second output.

8. The method of claim 1, wherein treating the lossy data includes one or more of an up-scaling operation, a down-scaling operation, a smoothing operation, an aggregation operation, a generalization operation, or a normalization operation.

9. The method of claim 1, wherein a single architecture includes a combination of the data enhancer and the ML classifier.

10. The method of claim 1, wherein the data enhancer refrains from accessing the parameters of the ML classifier.

11. A non-transitory storage medium having stored therein instructions that are executable by one or more hardware processors to cause the one or more hardware processors to:
receive data over a network connection, wherein the data is lossy data, and wherein the lossy data includes one or more distortions as compared to an original version of the data;
access a data enhancer that operates in conjunction with a machine learning (ML) classifier tasked with solving an end-task, wherein:
the ML classifier is pre-trained to solve end-tasks, said pre-training being based on raw, non-lossy data,
parameters of the ML classifier are caused to remain unchanged for at least a determined period of time, and
the data enhancer is trained to minimize an error of the ML classifier by treating the lossy data prior to the lossy data being submitted to the ML classifier;
cause the data enhancer to treat the lossy data in a manner that prevents use of the lossy data by the ML classifier from introducing a bias into a classification operation performed by the ML classifier; and
in response to accessing treated lossy data from the data enhancer, cause the ML classifier to perform the classification operation using the treated lossy data.

12. The non-transitory storage medium of claim 11, wherein the data enhancer refrains from accessing the parameters of the ML classifier.

13. The non-transitory storage medium of claim 11, wherein the lossy data is received from an edge network device, and wherein the lossy data was previously subjected to a data compression operation and a data decompression operation.

14. The non-transitory storage medium of claim 11, wherein said network connection is a limited bandwidth network channel such that the lossy data is received over the limited bandwidth network channel.

15. The non-transitory storage medium of claim 11, wherein said pre-training of the ML classifier includes:
causing the ML classifier to classify an original set of raw data to produce a first output;
compressing the original set of raw data to produce compressed data;
decompressing the compressed data to produce lossy decompressed data;
causing the data enhancer to treat the lossy decompressed data to produce training treated lossy data;
causing the ML classifier to classify the training treated lossy data to produce a second output;
comparing the first output and the second output to determine a loss between the first output and the second output;
updating parameters of the data enhancer based on the determined loss between the first output and the second output.

16. A computer system comprising:
one or more processors; and
one or more hardware storage devices that store instructions that are executable by the one or more processors to cause the computer system to:
receive data over a network connection, wherein the data is lossy data, and wherein the lossy data includes one or more distortions as compared to an original version of the data;
access a data enhancer that operates in conjunction with a machine learning (ML) classifier tasked with solving an end-task, wherein:
the ML classifier is pre-trained to solve end-tasks, said pre-training being based on raw, non-lossy data,
parameters of the ML classifier are caused to remain unchanged for at least a determined period of time, and
the data enhancer is trained to minimize an error of the ML classifier by treating the lossy data prior to the lossy data being submitted to the ML classifier;
cause the data enhancer to treat the lossy data in a manner that prevents use of the lossy data by the ML classifier from introducing a bias into a classification operation performed by the ML classifier; and
in response to accessing treated lossy data from the data enhancer, cause the ML classifier to perform the classification operation using the treated lossy data.

17. The computer system of claim 16, wherein the data enhancer refrains from accessing the parameters of the ML classifier.

18. The computer system of claim 16, wherein the lossy data is received from an edge network device, and wherein the lossy data was previously subjected to a data compression operation and a data decompression operation.

19. The computer system of claim 16, wherein said network connection is a limited bandwidth network channel such that the lossy data is received over the limited bandwidth network channel.

20. The computer system of claim 16, wherein said pre-training of the ML classifier includes:
causing the ML classifier to classify an original set of raw data to produce a first output;
compressing the original set of raw data to produce compressed data;
decompressing the compressed data to produce lossy decompressed data;
causing the data enhancer to treat the lossy decompressed data to produce training treated lossy data;
causing the ML classifier to classify the training treated lossy data to produce a second output;
comparing the first output and the second output to determine a loss between the first output and the second output;
updating parameters of the data enhancer based on the determined loss between the first output and the second output.
